(19) United States
(12) Patent Application Publication
(10) Pub. No.: US 2003/0189271 A1
(43) Pub. Date: Oct. 9, 2003

(54) Method of making a door panel having a decorative insert

(76) Inventors: Kevin Allen Kieltyka, Rochester, MI (US); Giancarlo Granata, Sterling Heights, MI (US); Joseph Bonafiglia, Langhorne, PA (US); DuWayne McDowell, Greenwood, MI (US); Srinivas Kotha, Sterling Heights, MI (US)

Correspondence Address: BRINKS HOFER GILSON & LIONE, P.O. BOX 10395, CHICAGO, IL, 60611, US

(21) Appl. No.: 10/117,743

(22) Filed: Apr. 5, 2002

(51) Int. Cl. B27N 3/10

(52) U.S. Cl. 264/255; 264/320; 264/322; 264/257

(57) ABSTRACT

The present invention provides a door panel having a decorative insert integrally attached to the door panel. In one embodiment, the method of forming the door panel comprises forming the decorative insert by preheating a substrate and placing a coverskin on top of the substrate. The substrate and the, coverskin are subject to a compression molding process to form the decorative insert. The decorative insert is then disposed inside a second molding tool and a plastic material is injected into the cavity of the second molding tool. The plastic material then forms the door panel.

### TECHNICAL FIELD

This patent discloses and claims a useful, novel, and unobvious invention for a trim panel for use in motor vehicles.

### BACKGROUND

It is known to provide a trim panel assembly for an automotive vehicle to present an aesthetically pleasing appearance in an occupant compartment of the automotive vehicle. Trim panels have typically been used in headliners, instrument panels, and doors. The current automotive interior styling trend is toward a softer, wrap-around styling vision which places special emphasis on the tactile feel of the interior, as well as the visual impression. The hard plastic substrates and surfaces of car interiors in past years are being replaced by the trend toward padded or cushioned surfaces, covered by either vinyl or textile materials.

Current interior trim suppliers are using a variety of methods to apply the layer of exposed surface and padding to the substrates of interior trim systems. The most common and least technologically advanced method is applying the coverings to the substrate by hand. The layers are hand laid over a finished substrate and then pushed, pulled, tucked, and pinched into the contour of the substrate. The layers are secured with adhesives and/or mechanical fasteners such as staples or the like. Obviously hand applied trim panels have high labor costs.

However, it is desirable to provide a trim panel assembly with reduced mass, tooling, and equipment per vehicle. Therefore, there is a need in the art to improved method of making a trim panel assembly having a decorative inset for an automotive vehicle.

### SUMMARY

The present invention provides a door panel having a decorative insert integrally attached to the door panel. The method of forming the door panel comprises the step of first forming the decorative insert by preheating a substrate and placing a coverskin on top of the substrate. The substrate and the coverskin are subject to compression molding process to form the decorative insert. The decorative insert is then placed inside a second molding tool and a plastic material is injected inside the second molding tool. The plastic material then forms the door panel.

### BRIEF DESCRIPTION OF THE FIGURES

FIG. 1 is a perspective view of a panel, preferably a door panel in the interior of a motor vehicle, according to the teachings of the present invention;

FIG. 2 is a perspective view of the decorative insert, according to the teachings of the present invention;

FIG. 3 is a cross sectional view of the first molding tool for forming a decorative insert, according to the teachings of the present invention;

FIG. 4 is a flow chart representation of the first method of forming the panel with the decorative insert, according to the teachings of the present invention; and

FIG. 5 is a flow chart representation of the second method of forming the panel with the decorative insert, according to the teachings of the present invention

### DETAILED DESCRIPTION

The following description of the preferred embodiments is merely exemplary in nature, and is in no way intended to limit the invention or its application or uses.

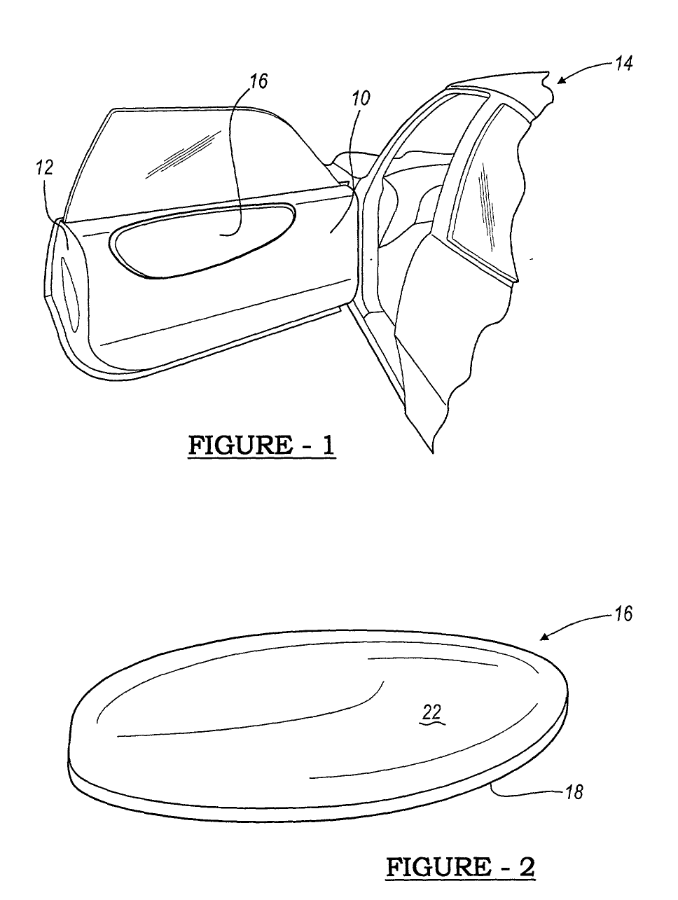

Referring to the drawings and in particular FIG. 1 a panel 10, according to the present invention, is shown mounted to a door 12 of a vehicle 14. It should be appreciated that the panel 10 may be mounted to other panels of the vehicle 14 such as instrument panels, headliners, arm rests, center consoles, seating, head rests, or vehicle pillars.

The panel 10 extends longitudinally and vertically and has a generally rectangular shape. The panel 10 is made of a plastic material such as polypropylene. Alternatively, the panel 10 may be made of expanded polypropylene. The panel 10 is formed by a method, according to the present invention, to be described below.

The panel 10 also includes a plurality of components integrated into the surface of the door panel 10. As shown in FIG. 1, the component includes a decorative insert 16. The decorative insert 16 extends longitudinally and vertically. The decorative insert 16 is bonded to the panel 10 by a method described below. It should be appreciated that the decorative component 16 is a separate piece or a component and is not integrally formed in the panel 10. However, as will be explained in details, the decorative insert 16 is integrally attached to the panel 10 without any secondary process such as adhesives, heat stacking etc.

As shown in FIG. 2, the decorative insert 16 is made of a natural fiber composite or Woodstock materials. In order to form the decorative insert, it is preferred that the density of the natural fiber composites or Woodstock materials is approximately 200 to 1600 g/m². The natural fibers are derived from plants such as kenaf, hemp, flax, jute, and sisal. These natural fibers are mixed with polypropylene and/or PET to form the natural fibers composites used in the present invention.

The decorative insert 16 is covered with a coverskin material 22, having a coverskin backing and presents a class A surface that is know in the art. As shown in FIG. 1, the class A surface is exposed to the interior of the motor vehicle 14. The coverskin backing material is preferably formed of a polypropylene, either foamed, film or fabric. The coverskin may be PP, PVC, cloth, or leather. The coverskin material is integrally attached to natural fiber composites or Woodstock materials by a method described below.

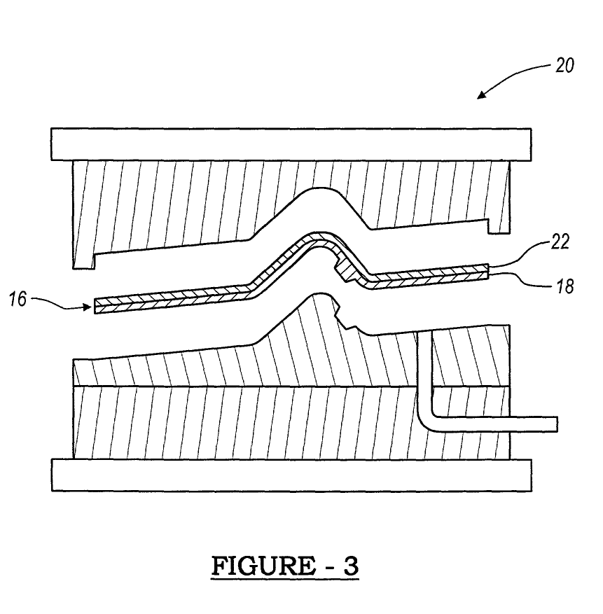

Referring in particular to FIG. 3, a method of making the decorative insert 16 is disclosed. In order to form the decorative insert 16, a suitable substrate 18 such as a natural fiber composite or a Woodstock sheet is heated to a pliable state. The heated substrate 18 is then loaded into a first molding tool 20 such as a compression tool along with the coverskin material 22. The substrate 18 and the coverskin material 22 are then subject to compression molding such that the coverskin 22 integrally attaches to the surface of the substrate 18 to form the decorative insert 16. The adhesion of the coverskin 22 to the substrate 18 is facilitated due to the presence of polypropylene and/or polyethylene fibers in the substrate 18 and PP or PE backing on the coverskin 22 such that during compression a chemical bond by fusion occurs between the backing on the coverskin 22 and the polypropylene in the substrate 18. Other conventional processes such as injection molding or other suitable thermoplastic molding may be employed to form the decorative insert. After the compression molding process is completed, the decorative insert 16 (formed part shown in FIG. 2) is removed from the tool and subjected to the method described below.

The decorative insert 16 formed from the process mentioned above is then inserted into a second molding tool molding tool. The second molding tool is preferably an injecting molding tool, such that injection molding process is used to form the panel 10. Alternatively, the second molding tool is a foamed polypropylene tool, such that the panel 10 is formed by the expansion of the plastic material. Irrespective of the kind of molding tool used, the molding tool includes a lower mold and an upper mold. The upper mold and the lower mold each include a mold cavity respectively, for forming the door panel 10. The lower mold includes at least one, preferably a plurality of gates or inlets to fill the mold cavity with the plastic material used for forming the panel 10. It should be appreciated that the molding tool is conventional and known in the art and therefore not explained in detail.

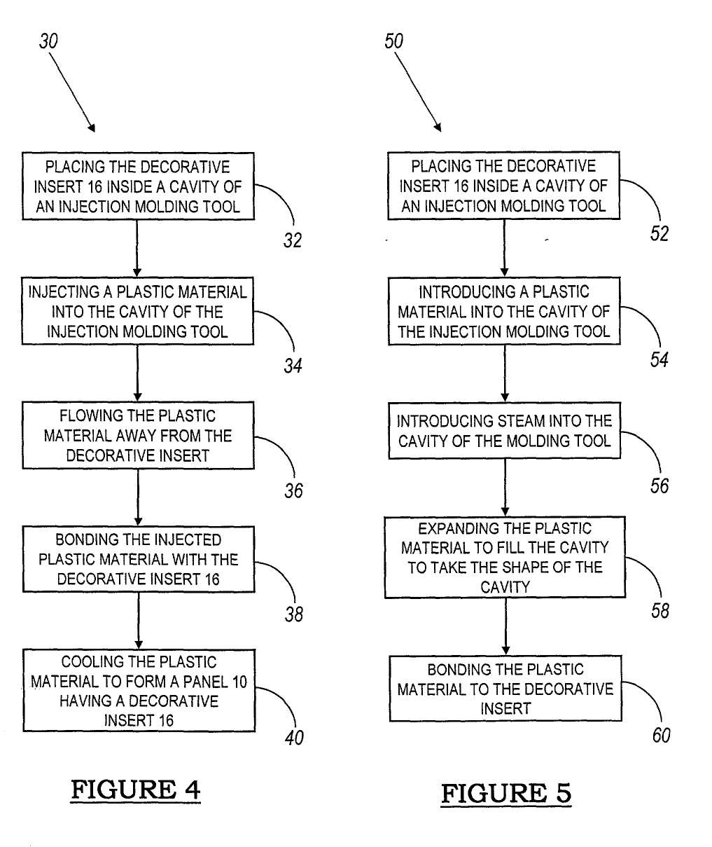

Referring in particular to FIG. 4, a first method of forming the panel 10 having the decorative insert 16 by the injection molding process is generally represented by reference numeral 30. The method first includes the step of placing the decorative insert 16 into the cavity of the injection molding tool, as shown by block 32. In the next step, as shown by block 34, the plastic material is introduced into the cavity through the gates of the injection molding tool. In the preferred embodiment the plastic material is polypropylene. In order to prevent the plastic material from flowing on top of the coverskin 22 of the decorative insert 16, the decorative insert 16 is positioned inside the cavity such that gates are behind the decorative insert 16. The method further includes the step of flowing the plastic material away from the decorative insert 16, as shown by block 36. The plastic material is then bonded to the decorative insert 16 such that the polypropylene and/or polyethylene fibers present in the natural fiber or Woodstock of the decorative insert 16 melt and fuse to form a mechanical and a thermoplastic bond between the plastic material forming the panel 10 and the decorative insert 16, as shown by block 38. Finally, the method further comprises the step of cooling the mold by having cooling channels to cure the plastic material, as represented by block 40.

Referring in particular to FIG. 5, a second method of forming the panel 10 with the decorative insert 16 is generally represented by reference numeral 50. In this method, like the first method, the decorative insert 16 is placed inside the cavity of the molding tool, as shown by block 52. In the next step, as shown by block 54, the plastic material is introduced into the cavity through the gates of the tool. In the preferred embodiment the plastic material is expanded polypropylene. The next step includes the step of introducing steam inside the mold, as shown by block 56. The next step involves expanding the polypropylene bead material to fill the cavity, as shown by block 58. The panel 10 is attached to the decorative insert 16 by fusing the hot polypropylene foam with the natural fiber or Woodstock of the decorative insert 16, as represented by block 60. Finally, the method includes the step of cooling the mold by spraying a coolant such as water. Once the door panel 10 having the decorative insert 16 is cooled, the mold is opened and the door panel 10 is removed from the mold.

As seen from the above, the above described process of forming a door panel 10 having a decorative insert 16 substantially eliminates the need to attach components such as a decorative insert 16 by secondary operations such as heat staking, adhesives, etc. The above method also prevents overflow of the plastic material into the class A surface.

As any person skilled in the art will recognize from the previous description and from the figures and claims, modifications and changes can be made to the preferred embodiments of the invention without departing from the scope of the invention.

What is claimed is:

1. A method of making a door panel having a decorative insert integrally attached to the door panel in an interior of a motor vehicle, the method comprising:
forming the decorative insert in a first molding tool;
removing the decorative insert from the first molding tool;
disposing the decorative insert inside a cavity of a second molding tool;
injecting a plastic material into the cavity of the second molding tool; and
bonding the door panel to the decorative insert.

2. The method of claim 1 wherein the act of forming the decorative insert includes expanding the plastic material to form the decorative insert comprises the step of forming the decorative insert.

3. The method of claim 1 wherein the act of forming the decorative insert comprises:
pre-heating a natural fiber mat substrate;
placing a coverskin on a top surface of the substrate; and
inserting the substrate with the coverskin into the first molding tool.

4. The method of claim 3 wherein the natural fiber mat is formed of a natural fiber selected from a group consisting of kenaf, hemp, flax, jute, or sisal mixed with polypropylene or PET.

5. The method of claim 3 wherein the coverskin is formed of a material consisting of PP, PVC, cloth, or leather with a backing of spun-bond polypropylene or extruded polypropylene.

6. The method of claim 1 wherein the act of forming the decorative insert comprises forming the decorative insert by compression molding process.

7. The method of claim 1 wherein the second molding tool is an injection molding tool.

8. The method of claim 1 wherein the second molding tool is a foamed polypropylene tool.

9. The method of claim 1 wherein the plastic material is polypropylene.

10. The method of claim 1 wherein the act of injecting the plastic material comprising injecting the plastic material away from the decorative insert.

11. The method of claim 1 wherein the act of injecting a plastic material and the act of bonding the door panel occur simultaneously.
